(19) United States
(12) Patent Application Publication
(10) Pub. No.: US 2013/0208073 A1
(43) Pub. Date: Aug. 15, 2013

(54) ICIGAR BRANDING MACHINE

(71) Applicants: Nabil Lawandy, Saunderstown, RI (US); William Clark, (US)

(72) Inventors: Nabil Lawandy, Saunderstown, RI (US); William Clark, (US)

(73) Assignee: SOLARIS NANOSCIENCES CORPORATION, Providence, RI (US)

(21) Appl. No.: 13/396,310

(22) Filed: Feb. 14, 2012

(51) Int. Cl. B41J 2/435; B41F 17/14

(52) U.S. Cl. 347/224; 101/35

(57) ABSTRACT

A device is disclosed for the application of customizable indicia to the outer surface of a smoking article such as a cigar. The device employs thermal means to apply indicia in a controlled and customized manner that allows easy branding of cigars. The device includes a thermal branding head, a cradle for holding the smoking article, a heating element, a control circuit to control the temperature of the heating element and branding head, an actuator to move the branding heat into contact with a cigar contained within the cradle and a timing circuit to determine how long the branding head shall be in contact with the cigar.

### BACKGROUND OF THE INVENTION

The present invention relates generally to a device for applying indicia to the outer surface of smoking articles, such as cigars for example. More specifically, the present invention relates to a device that applies indicia to the outer tobacco wrapper disposed about smoking articles in a manner that reliably imprints the wrapper without damaging or crushing the smoking article.

It is known in the art that cigars typically are wrapped with a natural tobacco leaf or with a manufactured wrapper that contains both natural tobacco and certain adhesives and cellulosic fiber materials. The advantage of using a manufactured cigar wrapper rather than a natural tobacco leaf resides in its considerably lower cost and the increased ability to manipulate both taste and aroma by the addition of appropriate additives. The natural tobacco leaf has historically however, been the symbol of a quality cigar.

In this regard, cigar wrapper manufacturers have, on numerous occasions, attempted to print indicia or a pattern on the wrapper material. For example, U.S. Pat. No. 2,316,785, which issued to Frederick C. Gladeck on Apr. 20, 1943, discloses the embossing of a sheet of manufactured tobacco wrapper with a pattern which simulates leaf tobacco. See also, in this regard, U.S. Pat. No. 3,145,717 which issued to F. H. Osborne et al. on Aug. 25, 1964 and which discloses that calendering or embossing of a manufactured cigar wrapper with a leaf design having stems and veins.

Additionally, other rudimentary systems exist for imprinting indicia such as lettering onto finished cigars. In this regard, U.S. Pat. No. 414,075, issued to Irving Paine on Oct. 29, 1889 provides for a simple folding device with a heated brand contained therein for burning the indicia into the cigar surface. Similarly, U.S. Pat. No. 1,938,969, issued to James McKinnon on Dec. 12, 1933 provides for the addition of a heat branding station within the structure of an automated cigar wrapping machine.

The difficulty with the prior art devices is that they are not easily customizable to tailor the branded indicia at will. Further the systems are much too rudimentary to allow a user to adjust the system to allow control over the process for lighter or darker colored cigars.

There is therefore a need for a device for applying customized indicia to the outer surface of a smoking article and more specifically a cigar. There is a further need for a device that is easily customizable to adjust the indicia applied to a smoking article while also including a control system that allows consistent and reliable application thereof.

### BRIEF SUMMARY OF THE INVENTION

In this regard, the present invention provides a device for the application of customizable indicia to the outer surface of a smoking article such as a cigar. As such, the general purpose of the present device, which will be described subsequently in greater detail, is to provide a new and improved assembly whereby thermal means is used to apply indicia in a controlled and customized manner. This allows easy branding of cigars with any variety of indicia including the actual brand of the cigar, a message, a special occasion, the name of the store where the cigar was purchased, etc.

The device includes a thermal branding head, a cradle for holding the smoking article, a heating element, a control circuit to control the temperature of the heating element and branding head, an actuator to move the branding head into contact with a cigar contained within the cradle and a timing circuit to determine how long the branding head shall be in contact with the cigar. In this manner a simple apparatus is provided that allows easy customization of the message being imprinted as well as convenient branding of small batches of cigars as needed.

Accordingly, it is an object of the present disclosure to provide a device for applying customized indicia to the outer surface of a smoking article and more specifically a cigar.

It is a further object of the present disclosure to provide a device that is easily customizable to adjust the indicia applied to a smoking article while also including a control system that allows consistent and reliable application thereof.

It is still a further object of the present disclosure to provide a simple apparatus that allows easy customization of the message being imprinted as well as convenient branding of small batches of cigars as needed.

[12] These together with other objects of the invention, along with various features of novelty which characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In the drawings which illustrate the best mode presently contemplated for carrying out the present invention:

FIG. 1 is a front perspective view of a cigar branding device;

FIG. 2 is an alternate front perspective view of a cigar branding device;

FIG. 3 is an illustration of an embodiment of a branding head for the cigar branding machine; and

FIG. 4 is an illustration of the branding head of FIG. 3 in operation; and

FIGS. 5 and 6 are illustrations of alternate branding heads.

### DETAILED DESCRIPTION OF THE INVENTION

Now referring to the drawings, the device for applying indicia to smoking articles is generally illustrated at 10 in the figures. The device provides for the application of customizable indicia to the outer surface of a smoking article such as for example a cigar. As such, the general purpose of the present branding device 10, is to provide a new and improved assembly whereby thermal means is used to apply indicia in a controlled and customized manner. This allows easy branding of cigars with any variety of indicia including the actual brand of the cigar, a message, a special occasion, the name of the store where the cigar was purchased, etc.

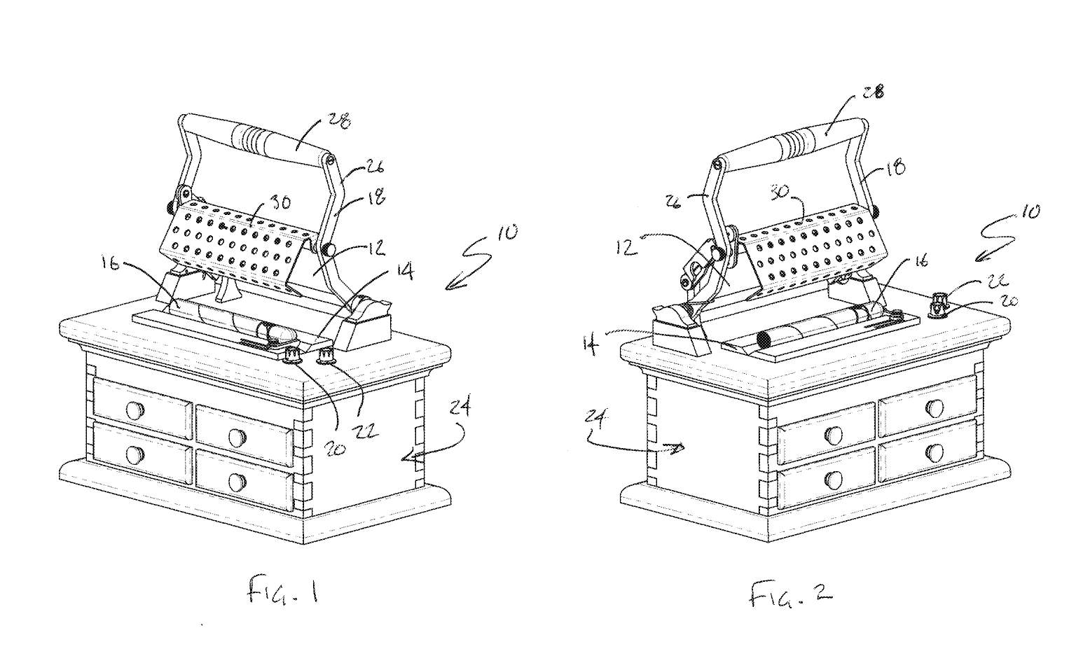

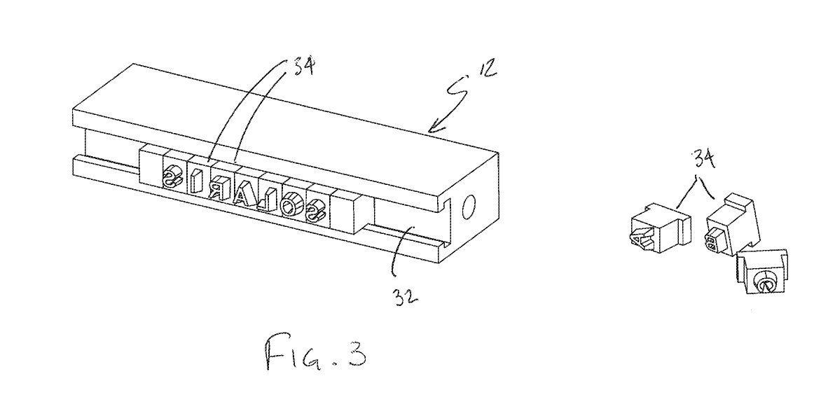

As can best be seen in FIGS. 1 and 2, the branding device 10 generally includes a thermal branding head 12, a cradle 14 for holding the smoking article 16, a heating element contained within the branding head 12, a control circuit 20 to control the temperature of the heating element and branding head, an actuator 18 to move the branding head 12 into contact with a cigar 16 contained within the cradle 14 and a timing circuit 22 to determine how long the branding head 12 shall be in contact with the cigar 16. In this manner a simple apparatus is provided that allows easy customization of the message being imprinted as well as convenient branding of small batches of cigars as needed.

The figures also depict the device 10 to include optionally a case, stand or cabinet 24 to which the operational portion of the branding machine 10 is affixed. Such a cabinet 24 may take any variety of shapes, sized or configurations. The configuration shown in the figures is meant for illustrative purposes only and is not intended to limit the device and scope of the present invention in any manner. It can be seen the the cabinet 24 may include drawers 26 or storage spaces as needed. This allows a user of the device to neatly and conveniently store any variety of accessories that may be employed with the device.

The actuator 18 can be seen to include at least one lever arm 26 that supports the branding head 12. A user pulls the handle 28 attached to the at least one lever arm 26 to displace the branding head 12 and bring it into contact with the cigar 16. Further the actuator 18 can be seen to include a heat shield 30 that serves to protect a user from incidental contact with the hot branding head 12 when loading or removing cigars 16 from the cradle 18.

A stated above, the device 10 includes a thermal control circuit 20 and a timing circuit 22. Both of these circuits are adjustable by the user to increase and decrease both the amount of heat used for branding as well as the duration of time that the branding head 12 is applied to the cigar 16. The thermal control circuit 20 controls the amount of heat energy input into the branding head 12 and further includes a thermostat that monitors the temperature of the branding head so that the thermal control circuit can maintain a constant temperature as is set by a user interface such as a dial, a keypad, a digital temperature read out or a combination thereof. Further a visual indicator may be provided to indicate that the branding head is at the set temperature. Such temperature adjustments allow a user to create a uniform and quality brand on cigars having varying wrapper thicknesses and colorations.

The timing circuit 22 includes an indicator to inform the user that the branding cycle is complete. When the actuator is moved to place the branding head 12 into contact with the cigar 16, the timing circuit begins a countdown based on a preset time that is determined by a user interface such as a dial, a keypad, a digital timing read out or a combination thereof. The visual indicator changes to tell the user that the cycle is ended and the branding head 12 can be removed from the cigar 16.

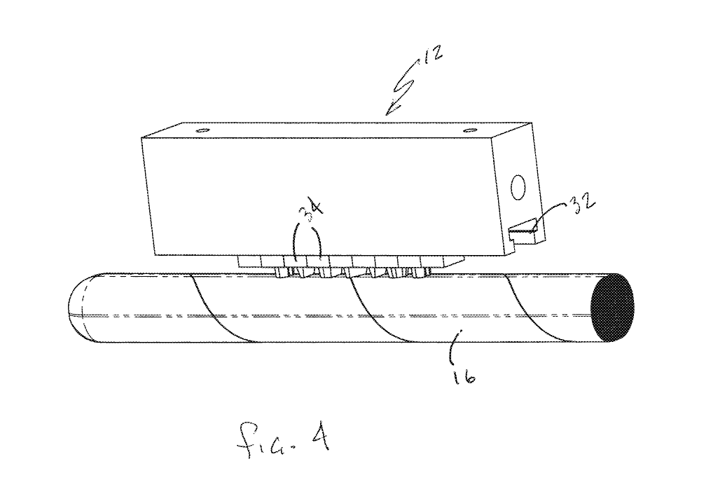

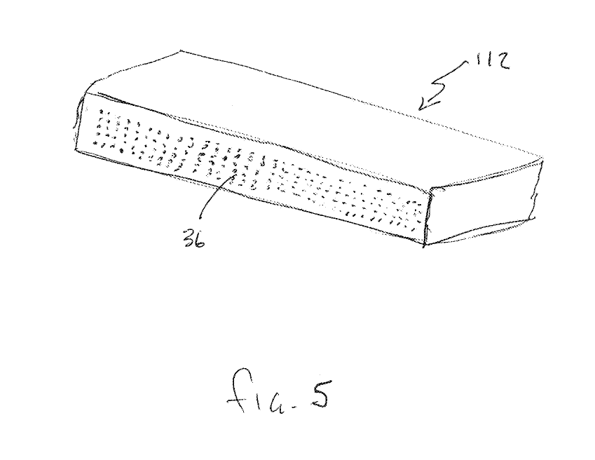

As is shown at FIGS. 3 and 4, the branding head 12 is depicted as a metallic block with a slot 32 therein. The slot may simply be rectangular or T-shaped as shown in the figures. Individual brands 34 are placed into the slot 32 so that they are retained within the branding head 12. The brands may be retained using the profile of the slot 32, friction, set screws, magnets or combinations thereof. The intent of the arrangement is that the individual brands 34 can be easily removed and reset to change the indicia being applied. Further, the brands 34 may include letters, numbers, symbols, graphics, patterns or any combination thereof. Also the brands 34 may bear individual indicia or composite groups of indicia on a single brand 34.

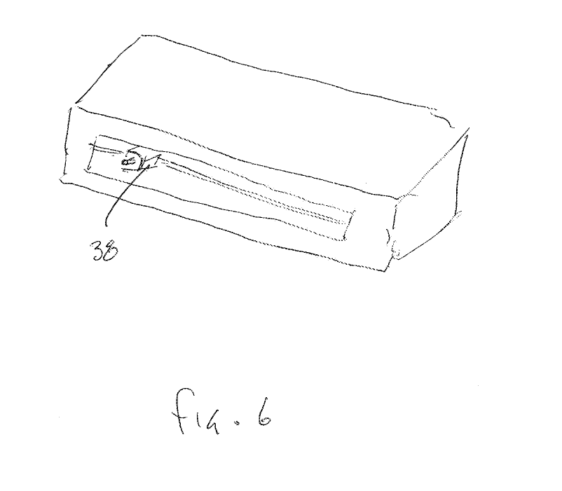

Turing to FIG. 5 an alternate branding head 112 is shown in the form of a thermal printer style device. The branding head 112 includes an array of individually actuated dots 36 dispersed thereon. The user employs a user interface to control which of the dots 36 within the array are actuated to in turn imprint the desired indicia or pattern onto a cigar. Similarly, FIG. 6 depicts a branding head 212 that employs a programmable laser 38 that is programmed using a user interface to control the movement pattern of the laser 38 in order to imprint the desired indicia or design onto a cigar 16.

Accordingly, it can therefore be seen that the present disclosure provides a device for applying customized indicia to the outer surface of a smoking article and more specifically a cigar that is easily customizable to adjust the indicia applied to a smoking article while also including a control system that allows consistent and reliable application thereof. It can also be seen that the present disclosure provides a simple apparatus that allows easy customization of the message being imprinted as well as convenient branding of small batches of cigars as needed. For these reasons, the instant invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A device for applying indicia to a smoking article, comprising:
a thermal branding head configured for the application of customizable indicia to said smoking article, said thermal branding head supported in an actuator;
a cradle for receiving and supporting said smoking article; and
a control circuit for controlling a temperature of said thermal branding head,
wherein said actuator is displaceable between an open position and a closed position wherein said thermal branding head is in contact with said cigar.

2. The device of claim 2, said control circuit including a user interface for setting said temperature and being selected from the group consisting of: a dial, a keypad, a digital timing read out and a combination thereof.

3. The device of claim 1, further comprising:
a timing circuit that indicates a time duration that said thermal branding head is in contact with said cigar.

4. The device of claim 3, further comprising:
a user interface that allows said time duration to be set by a user of the device.

5. The device of claim 4, said user interface being selected from the group consisting of: a dial, a keypad, a digital timing read out and a combination thereof.

6. The device of claim 3, further comprising:
a visual indicator that indicates that said thermal branding head has been in contact with said cigar for a predetermined time interval.

7. The device of claim 1, further comprising:
a heat shield proximate said thermal branding head.

8. The device of claim 1, further comprising:
a cabinet.

9. The device of claim 1, wherein said indicia wherein said customizable indicia are removable secured within a slot in said branding head.

10. The device of claim 9, wherein said indicia are retained in said slot form the group consisting of: a profile of the slot, friction, set screws, magnets and combinations thereof.

11. The device of claim 1, wherein said thermal branding head is a thermal print head.

12. The device of claim 1, wherein said thermal branding head includes a movable laser etching device.
